(19) United States
(12) Patent Application Publication
(10) Pub. No.: US 2013/0140082 A1
(43) Pub. Date: Jun. 6, 2013

(54) WIRE CONNECTOR ASSEMBLY INCLUDING SPLICE ELEMENTS FOR FLUID ENVIRONMENTS AND METHOD OF MAKING SAME

(71) Applicant: DELPHI TECHNOLOGIES, INC., TROY, MI (US)

(72) Inventors: STEVEN WILLING, ENCINITAS, CA (US); FEDERICO KELLENBERGER, TECATE (MX); ERIC J. SMOLL, FONTANA, CA (US); BAO Q. LE, SANTA ANA, CA (US)

(73) Assignee: DELPHI TECHNOLOGIES, INC., TROY, MI (US)

(21) Appl. No.: 13/757,201

(22) Filed: Feb. 1, 2013

Related U.S. Application Data
(63) Continuation-in-part of application No. 13/423,325, filed on Mar. 19, 2012.
(60) Provisional application No. 61/514,951, filed on Aug. 4, 2011.

(51) Int. Cl. H01R 4/10; H01R 4/18

(52) U.S. Cl. CPC H01R 4/10; H01R 4/18
USPC 174/84 C; 174/84 R; 29/874

(57) ABSTRACT

A wire connector assembly configured to inhibit leakage of fluids between two distinct environments and a method of constructing same is presented. The assembly includes insulated wire cables having ends that are spaced apart and joined by a wire splice element within a connector body, thereby interrupting a fluid leak path through the strands of the wire cables. The connector body may be over-molded the wire splice elements and a portion of connector body may be disposed intermediate to the ends of the wire cables, providing an additional physical barrier to the fluid leak path. The wire splice element may include wire crimp wings that are crimped to the ends of the wire cable. The wire splice elements may also include insulation crimp wings that may be crimped to the insulation to prevent insulation on the wire cables from pulling back and exposing wire strands.

### CROSS-REFERENCE TO RELATED APPLICATION

This application is a continuation-in-part application and claims the benefit under 35 U.S.C. §120 of U.S. patent application Ser. No. 13/423,325, filed Mar. 19, 2012, which claims the benefit under 35 U.S.C. §119(e) of U.S. Provisional Patent Application No. 61/514,951, filed Aug. 4, 2011, the entire disclosure of which is hereby incorporated herein by reference.

### TECHNICAL FIELD OF INVENTION

The invention relates to a wire connector assembly, more particularly, a wire feed-through connector assembly containing provisions that allow use of the wire connector assembly in fluid environments.

### BACKGROUND OF INVENTION

Some electrical applications require submersion of a wire connector assembly in a fluid environment. One example of a wire connector assembly includes wire conductors formed with an inner core that has individual wire strands covered by an insulative outer covering. A portion of the wire conductors are stripped free of the insulation covering and the stripped areas are subsequently tinned with solder. Tinning the wire strands fuses the wire strands together by forming a coat of solder on the wire strands resulting in a single, solid core wire connection. The tinned solid core wire connection creates a dam that acts as a leakage barrier to impede fluid flow into, and through the individual wire strands. The tinned solid core connections of the wire conductors are then over-molded with an electrically nonconductive material to form a molded connector body. The molded connector body is subsequently attached to a support structure within the fluid environment. This wire connector assembly design has several drawbacks. One drawback is that the solder may wick into the wire stands so that a tinned portion of the wire strands extend beyond a boundary of the molded connector body. This causes a portion of the wire conductor to be mechanically stiffer than the remaining wire conductor which reduces the flexibility and increases a bend radius of the wire conductor at the molded connector boundary which may inhibit a tight routing path desired in some electrical applications.

Other known wire connector configurations rely on the use of gaskets and/or glass-to-metal seals that increase the complexity of the wire connector assembly while undesirably adding increased cost to the wire connector assembly.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### SUMMARY OF THE INVENTION

In accordance with one embodiment of this invention, a wire connector assembly is provided. The wire connector assembly includes a connector body formed of a dielectric material and a plurality of wire cables formed of an electrically conductive inner core surrounded by an electrically insulative outer covering. Each wire cable has an outer covering end portion removed to expose an inner core end portion. Each inner core comprises a plurality of wire strands. The wire connector assembly further includes a wire splice element electrically and mechanically joining at least two inner core end portions. The at least two inner core end portions are axially spaced apart. The connector body encloses the wire splice element and sealably engages each outer covering of the plurality of wire cables.

The plurality of wire cables, the wire splice element, and the connector body may provide a fluid resistant electrically conductive path through the wire connector assembly. A portion of the connector body may be disposed intermediate to the at least two inner core end portions to provide a barrier to a fluid infiltrating the inner core of one of the plurality of wire cables.

The wire splice element may define a plurality of wire crimp wings. The wire crimp wings may be axially spaced apart. The wire splice element further may define a plurality of insulation crimp wings configured to retain the outer covering. The plurality of insulation crimp wings may be distinct from the plurality of wire crimp wings.

In another embodiment of the present invention, a method to fabricate a wire connector assembly is provided. The method includes the step of providing a plurality of wire cables and a wire splice element, wherein the plurality of wire cables are formed of an electrically conductive inner core surrounded by an electrically insulative outer covering. The method further includes the steps of removing the outer covering from an end of each wire cable to expose the inner cores of the plurality of wire cables, inserting the end of each wire cable in the wire splice element, electrically and mechanically attaching the end of each wire cable to the wire splice element to form a wire arrangement, inserting the wire arrangement into a mold, injecting a dielectric material in a fluid state into the mold to surround at least a portion of the wire arrangement containing the wire splice element to form the wire connector assembly, and hardening the dielectric material to a solid state, thereby forming a connector body. The connector body encloses the wire splice element and sealably engages the outer covering of the plurality of wire cables.

The wire splice element may define a plurality of wire crimp wings and the step of electrically and mechanically attaching the end of each wire cable to the wire splice element may further include the step of crimping the plurality of wire crimp wings to the end of each wire cable. The wire crimp wings may be axially spaced apart.

The step of injecting the dielectric material into the mold may include the step of injecting a portion of the dielectric material intermediate to the end of each wire cable to provide a barrier to a fluid infiltrating the inner core of one of the plurality of wire cables.

The wire splice element may further define a plurality of insulation crimp wings configured to retain the outer covering and the step of electrically and mechanically attaching the end of each wire cable to the wire splice element may include crimping the plurality of insulation crimp wings to the outer cover of each wire cable. The plurality of insulation crimp wings may be distinct from the plurality of wire crimp wings.

The step of inserting the wire arrangement into the mold may further include the step of arranging a plurality of wire arrangements in the mold so that the plurality of wire arrangements are electrically independent one-to-another.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 illustrates a wire connector assembly partially disposed within a fuel tank of a lawn mower in accordance with one embodiment;

FIG. 2 is a perspective view of a wire connector assembly in accordance with one embodiment;

FIG. 3 is a perspective view of a wire arrangement used in the wire connector assembly of FIG. 2 in accordance with one embodiment;

FIG. 4 is a cut away view of the wire connector assembly of FIG. 2 in accordance with one embodiment;

FIG. 5a is a side view of a wire splice element used in the wire connector assembly of FIG. 2 in accordance with one embodiment;

FIG. 5b is a top view of a wire splice element used in the wire connector assembly of FIG. 2 in accordance with one embodiment;

FIG. 6 is a block diagram of a process of aligning wire arrangements in a fixture that is positioned in a mold to produce the wire connector assembly of FIG. 2 in accordance with one embodiment;

FIG. 7 is a flow chart of a process of forming the wire connector assembly of FIG. 2 in accordance with one embodiment; and

FIG. 8 is an illustration of an outer covering pulling away from a connector body and exposing wire strands of the wire arrangement.

### DETAILED DESCRIPTION OF INVENTION

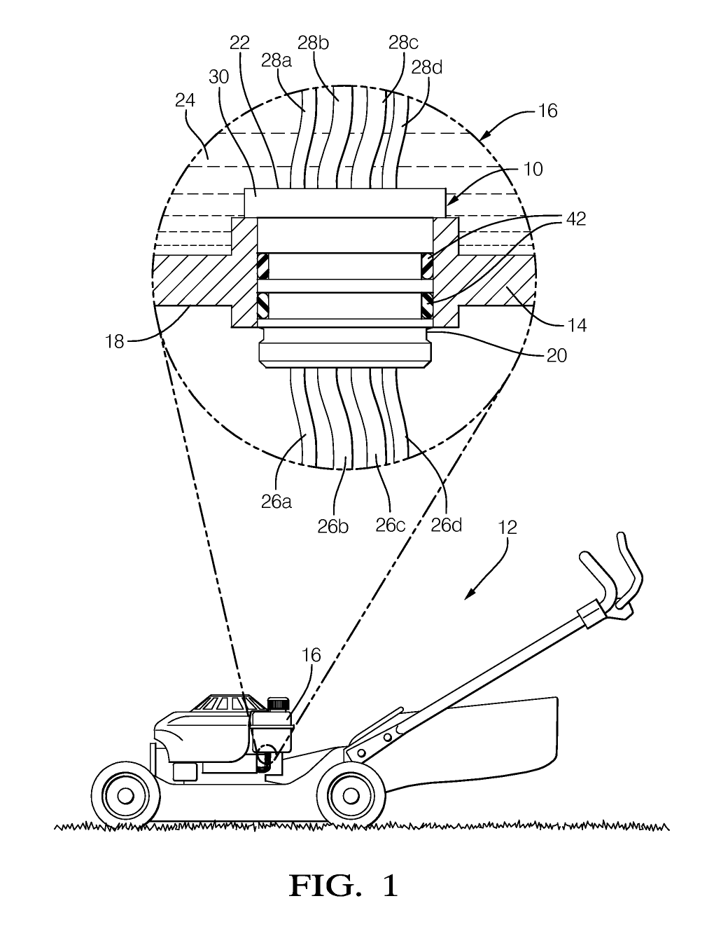

FIG. 1 illustrates a non-limiting example of a wire feed-through connector assembly 10, hereinafter the assembly 10, installed on a lawn mower 12. Assembly 10 is located within a wall 14, or bulkhead 14, of a fuel tank 16 of lawn mower 12 and electrically connects an electrical component (not shown) disposed in fuel tank 16, such as a fuel level sensor, to another electrical component (not shown), such as a fuel gauge, external to fuel tank 16. Thus, assembly 10 as disposed on lawn mower 12 is exposed to a gaseous fluid environment 18 (e.g. air) along a first portion 20 of assembly 10 while a second portion 22 of assembly 10 is exposed to a liquid fluid environment 24 (e.g. gasoline). As used herein, a fluid is defined as a liquid or a gas that is capable flowing when under pressure. When the second portion 22 of assembly 10 is surrounded by liquid fuel, assembly 10 is advantageously resistant to leakage of liquid fuel through the assembly 10. Other embodiments of the assembly 10 may be envisioned that are designed to be used in applications where the first and second portions 20, 22 of the assembly 10 are exposed to a gaseous fluid environment 18 or where the first and second portions 20, 22 of the assembly 10 are exposed to a liquid fluid environment 24.

When used in the fuel tank 16 shown in FIG. 1, the first plurality of wire cables 26a-d and the first portion 20 of assembly 10 are exposed to a gaseous fluid environment 18. The second plurality of wire cables 28a-d and the second portion 22 of the assembly 10 are exposed to a liquid fluid environment 24. Electrical signals are conducted by the first plurality of wire cables 26a-d though the gaseous fluid environment 18, or first environment 18, to a plurality of wire splice elements (not shown) within the connector body 30 and to the second plurality of wire cables 28a-d that conducts the electrical signals though the liquid fluid environment 24 that is a second environment 24 distinctly different from the first environment 18.

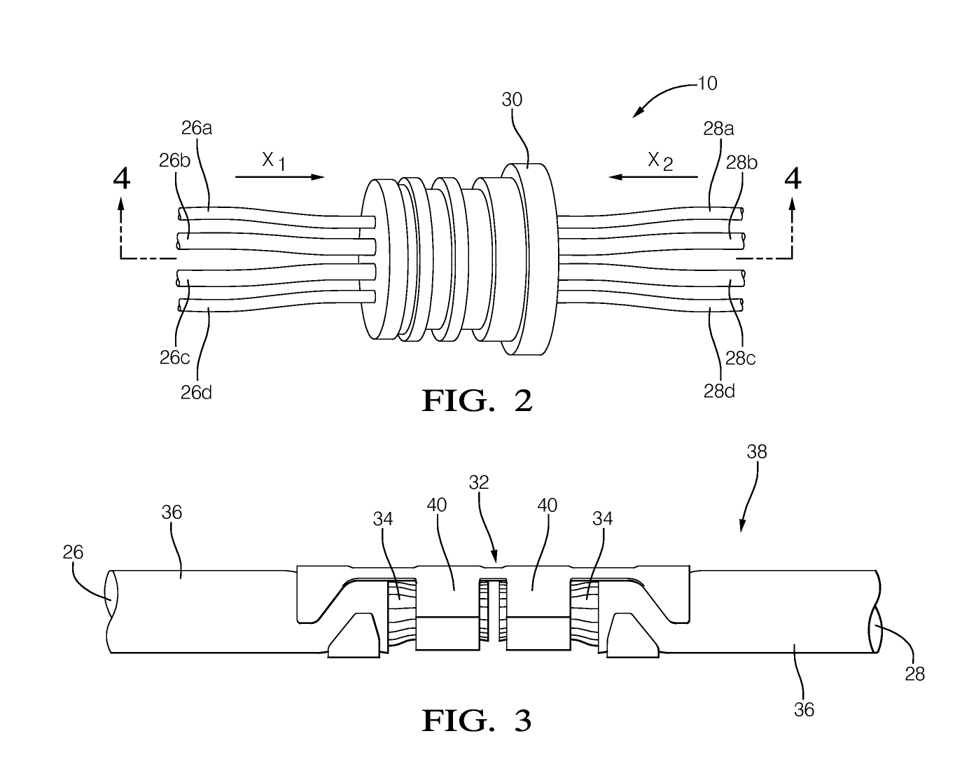

As shown in the non-limiting example of FIG. 2, the first plurality of wire cables 26a-d that enter a connector body 30 of assembly 10 and a second plurality of wire cables 28a-d that respectively exit the connector body 30 of assembly 10.

As shown in the non-limiting example of FIG. 3, the first wire cable 26 is mechanically and electrically joined to the second wire cable 28 by a wire splice element 32. Each wire cable is formed of an electrically conductive inner core 34 surrounded by an electrically insulative outer covering 36. Each wire cable has an outer covering 36 end portion removed to expose an inner core 34 end portion. Each inner core 34 is made up of a plurality of wire strands formed of a conductive material, such as a copper alloy or aluminum alloy. Multiple wire strands advantageously allow the wire cables 26, 28 to bend at an interface with connector body 30 without wire cable breakage in contrast to the tinned wire strands in wire feed-through connector assemblies cited in the Background as previously described herein. The outer covering may be formed of a dielectric material, such as polyvinylchloride (PVC), polytetrafluoroethylene (PTFE), or another suitable insulative material well known to those skilled in the art.

A first inner core 34 end portion of one of the first plurality of wire cables 26 is electrically and mechanically joined to a second inner core 34 end portion of one of the second of wire cables 28 by a wire splice element 32 to form a wire arrangement 38. In the illustrated example, the first inner core 34 end portion and the second inner core 34 end portion are axially spaced apart. Alternatively, other embodiments of the assembly 10 may be envisioned in which the first inner core 34 end portion and the second inner core 34 end portion are non-axially spaced apart, for example the end portions may be axially offset from each other or the end portions may be arranged perpendicular to each other.

In this non-limiting example, the wire splice element 32 defines a plurality of wire crimp wings 40 that are configured to be mechanically and electrically connected to the first inner core 34 end portion and the second inner core 34 end portion. The plurality of wire crimp wings 34 are spaced apart so that when the first and second inner core 34 portion are joined to the wire splice element 32, the first inner core 34 end portion and the second inner core 34 end portion are spaced apart. Without subscribing to any particular theory of operation, fluids may enter the wire cables 26, 28 through tears or openings in the outer covering 36 and flow though spaces or voids between the wire strands of the inner core 34. Because the ends of the wire cables 26, 28 are spaced apart, or separated, fluid entering the first wire cable 26 cannot directly continue its flow path to enter the second wire cable 28.

The design of wire splice elements 32 having wire crimp wings 34 and the methods used to mechanically and electrically attach wire splice elements 32 to wire cables 26, 28 are well known to those skilled in the art. While this example illustrates a wire arrangement 38 having two wire cables 26, 28 joined by a single wire splice element 32, other embodiments may be envisioned wherein three or more wire cables are joined by a single wire splice element 32.

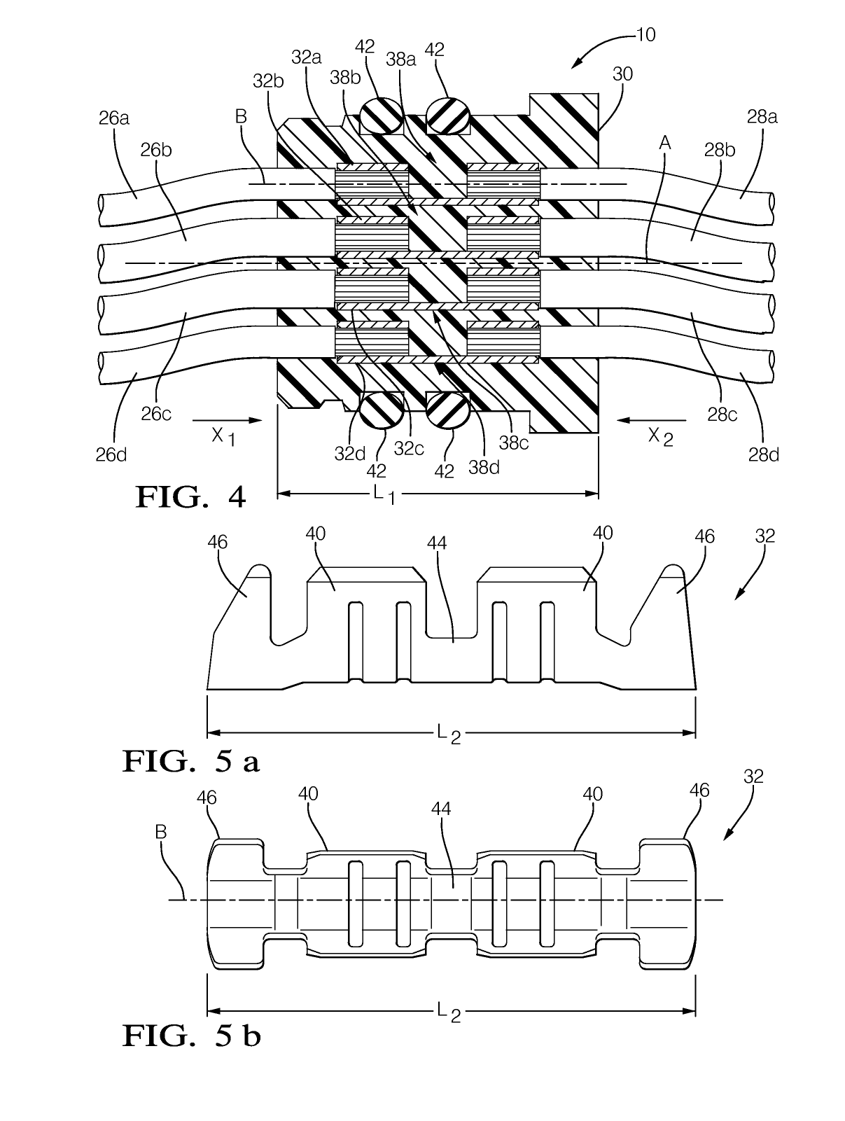

As shown in the non-limiting example of FIG. 4, the assembly 10 includes a plurality of wire arrangements 38a-d disposed within a connector body 30 formed of a dielectric material. The connector body 30 encloses the plurality of wire splice elements 32a-d and sealably engages each outer covering 34 of the plurality of the wire cables 26a-d, 28a-d. In this non-limiting example, the connector body 30 of the assembly 10 is sealably attached to the wall 14 of the fuel tank 16 using O-ring seals 42 disposed in grooves in the connector body 30. As shown in FIG. 4, a portion of the connector body 30 is disposed intermediate to the spaced apart first inner core 34 end portion and the second inner core 34 end portion. The portion of the connector body 30 that is disposed intermediate to the inner core 34 end portions will further inhibit fluid from flowing from the first wire cable 26 into the second wire cable 28 by forming a physical barrier between the first and second inner core ends.

The connector body 30 may be formed of a dielectric polymer material, such as polyamide (NYLON) or polybutylene terephthalate (PBT). Alternatively, the connector body 30 may be formed from an epoxy-based dielectric material that chemically bonds with the outer covering 36 of the wire cables 26, 28 and further seals the assembly 10 against fluid leakage entering the assembly 10. The epoxy-based material may provide more robust performance in an application where the assembly 10 will be exposed to chemicals or hydrocarbons because the epoxy-based material is less likely to soften or chemically break down over a time period when disposed these in these types of applications.

The wire connector assembly 10 may be useful in the motorized transportation industry such as electrically connecting fuel level sensors in fuel tank applications, or in other industries like chemical processing, or oil and gas exploration where electrical connections must cross a boundary of two different environments. Flame retardant and/or low toxicity plastic materials may be utilized to construct the connector body 30 when the assembly 10 is used for aerospace applications.

As illustrated in the non-limiting example of FIG. 4, the connector body 30 has a length L₁ disposed along longitudinal axis A of connector body 30. The first plurality of wire cables 26a-d and the second plurality of wire cables 28a-d axially extend away from connector body 30 in opposing directions to respectively electrically connect with other electrical circuits and/or electrical devices (not shown). The first plurality of wire cables 26a-d join with connector body 30 from a first direction Xᵢ and the second plurality of wire cables 28a-d join with connector body 30 from a second direction X₂ opposite first direction X₁.

The wire arrangements 38a-d are axially disposed within the connector body 30 and include wire splice elements 32a-d respectively disposed in connector body 30. Wire splice elements 32a-d are formed from an electrically-conductive material, such as a copper alloy or steel. The first inner core 34 end portions of the first plurality of wire cables 26a-d are disposed in one end of the wire splice elements 32a-d and are in intimate contact with the wire crimp wings 34 and the second inner core 34 end portions of the second plurality of wire cables 28a-d are disposed in the opposite end of the wire splice elements 32a-d and are in intimate contact with the wire crimp wings 34. The first inner core 34 end portions, the second inner core 34 end portions, and the wire splice elements 32a-d are enclosed by connector body 30. Wire splice elements 32a-d are further spaced apart one-to-another in a direction perpendicular to axis A within connector body 30 being spaced apart by portions of connector body 30, as best illustrated in FIG. 4. Accordingly, each wire arrangement 38a-d in the plurality of wire arrangements 38a-d is electrically independent from the other wire arrangements 38a-d when the wire splice elements 32a-d are disposed within the connector body 30. While the example of the assembly 10 having wire arrangements with an axial configuration is illustrated, embodiments of the assembly 10 with wire arrangements having non-axial configuration may also be envisioned

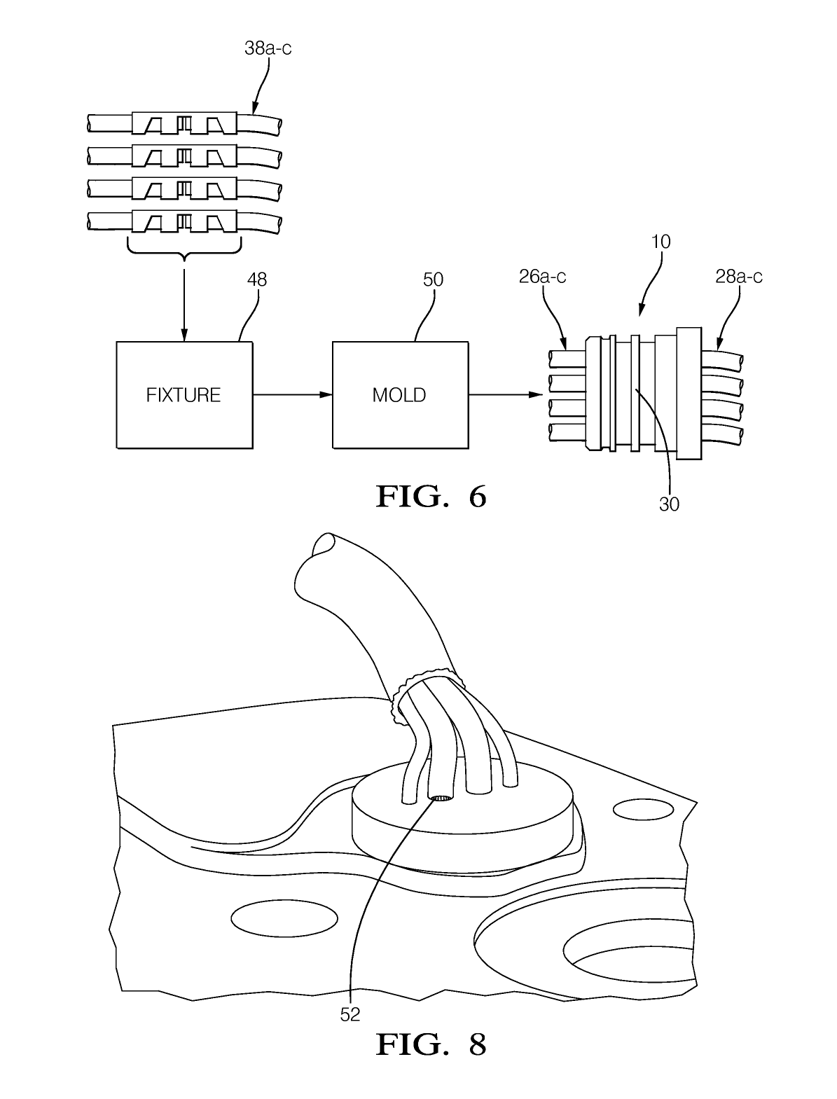

FIGS. 5a and 5b illustrate a non-limiting example of a wire splice element 32. The wire splice element 32 defines an axis B along a length L₂ of wire splice element 32. Length L₂ is less than length L₁ of the connector body 30. Axis B is typically parallel with axis A when wire splice element 32 is disposed in wire connector assembly 10 with other wire splice elements 32, as best illustrated in FIG. 4. A single wire splice element 32 is shown removed from the wire arrangement 30 of FIG. 3. The wire splice element 32 defines a pair of wire crimp wings 34 that are configured to mechanically and electrically connect the wire splice element 32 to the first inner core 34 end portion and the second inner core 34 end portion. The pair of wire crimp wings 34 are axially spaced apart from each other and the wire splice element 32 defines a connecting portion 44 intermediate to the pair of crimp wings. When the wire crimp wings 34 are closed over the inner core 34 ends, the connecting portion 44 will remain open. The wire splice element 32 also defines a pair of insulation crimp wings 46 that are configured to mechanically secure the outer covering 36 of the first wire cable 26 and the outer covering 36 of the second wire cable 28 to the wire splice element 32. The insulation crimp wings 46 are distinct from the wire crimp wings 34 and are disposed distal to the wire splice device 32. The wire splice device 32 may be formed by stamping and bending a sheet of conductive material using methods well known to those skilled in the art.

The connector body 30 may preferably be formed by molding the dielectric material around the wire arrangements 38. When the dielectric material is injected or poured in a fluid form into a mold containing the wire arrangements 38, the dielectric material may flow into the open connecting portion 44 and after the dielectric material hardens into a solid form, a portion of the connector body 30 is disposed intermediate to the inner core 34 end portions.

Referring to FIG. 6, wire arrangements 38a-c are arranged in a fixture 48 prior to the fixture 48 being moved to a molding machine 50 wherein connector body 30 is molded around the wire arrangements 38a-c. The fixture 48 may be formed from a steel or aluminum material.

The examples of the assembly 10 illustrate a configuration wherein the wire arrangements 38 are side-by-side. Alternatively, embodiments of the assembly 10 with other configurations of wire arrangements 38 may be envisioned. This may include, but is not limited to, an array of wire arrangements 38 within the connector body 30. One array may include wire arrangements 38 arrayed in rows and columns. An alternative array may have a staggered row arrangement. Alternatively, the assembly 10 may contain a single wire arrangement 38.

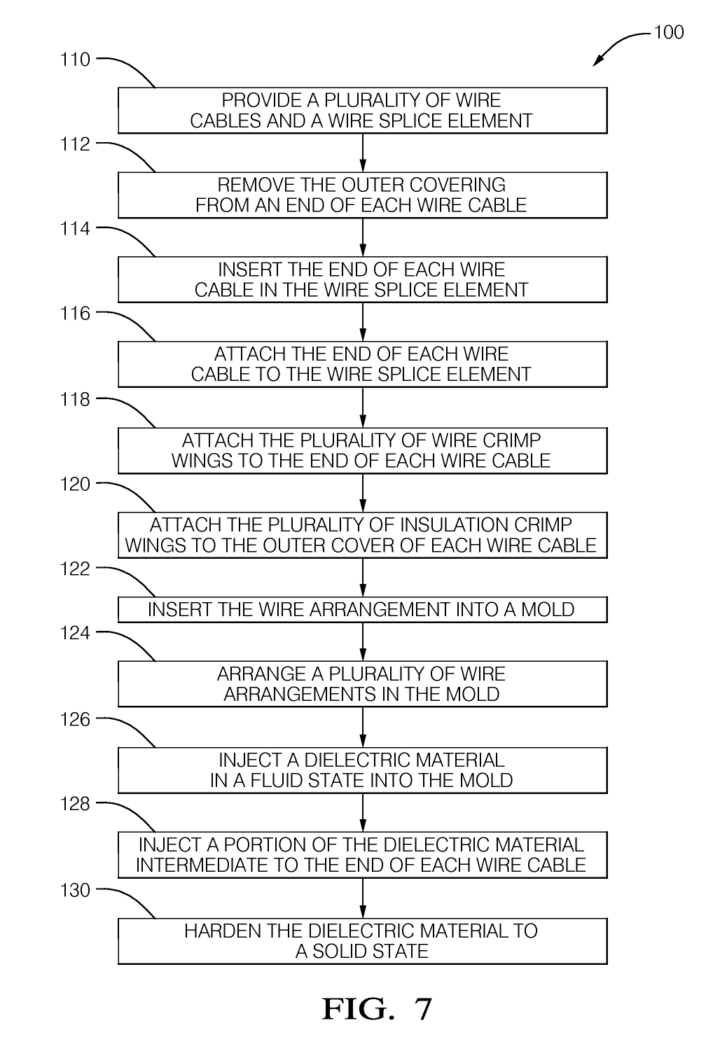

FIG. 7 illustrates a non-limiting method 100 of fabricating a wire connector assembly. The method 100 may include the following steps.

STEP 110, PROVIDE A PLURALITY OF WIRE CABLES AND A WIRE SPLICE ELEMENT, includes providing a plurality of wire cables 26.28 and a wire splice element 32. The plurality of wire cables 26, 28 are formed of an electrically conductive inner core 34 surrounded by an electrically insulative outer covering 36. The wire splice element 32 may define a plurality of wire crimp wings 34 configured to mechanically and electrically attach the wire splice element 32 to the inner core 34 of the wire cables 26, 28. The wire crimp wings 34 may be spaced apart from each other. The wire splice element 32 may also define a plurality of insulation crimp wings 46 configured to retain the outer covering. The plurality of insulation crimp wings 46 may be distinct from the plurality of wire crimp wings 34.

STEP 112, REMOVE THE OUTER COVERING FROM AN END OF EACH WIRE CABLE, includes removing the outer covering 36 from an end of each wire cable 26, 28 to expose the inner cores 34 of the plurality of wire cables 26, 28 by cutting away a portion of the outer covering 36.

STEP 114, INSERT THE END OF EACH WIRE CABLE IN THE WIRE SPLICE ELEMENT, includes inserting the end of each wire cable 26, 28 in the wire splice element 32. A first wire cable 26 and a second wire cable 28 may be inserted into the wire splice device 32 manually by a human assembly operator when at least one wire arrangement 38 is manually constructed.

STEP 116, ATTACH THE END OF EACH WIRE CABLE TO THE WIRE SPLICE ELEMENT, includes electrically and mechanically attaching the end of each wire cable 26, 28 to the wire splice element 32 to form a wire arrangement 38. At least one wire arrangement 38 is formed when the exposed ends of the inner metallic core 34 of the wire cables 26, 28 are electrically and mechanically attached to wire splice element 32.

Step 116 may optionally include STEP 118, CRIMP THE PLURALITY OF WIRE CRIMP WINGS TO THE END OF EACH WIRE CABLE which includes crimping the plurality of wire crimp wings 34 to the exposed end of each wire cable 26, 28. The crimping may result in a hermitic crimp that will reduce the spaces and void between the individual wire strands and create a barrier to fluid flow through ends of the inner cores 34 of the wire arrangement 38. The wire crimp wings 34 may be attached to the end of each wire cable 26, 28 using a crimping press as is also well known to those skilled in the art.

Step 116 may optionally include STEP 120, CRIMP THE PLURALITY OF INSULATION CRIMP WINGS TO THE OUTER COVER OF EACH WIRE CABLE, which includes crimping the plurality of insulation crimp wings 46 to the outer covering 36 of each wire cable 26, 28. The insulation crimp wings 46 may be attached to the outer covering 36 using a crimping press as is also well known to those skilled in the art. Crimping the plurality of insulation crimp wings 46 to the outer covering 36 of the wire cables 26, 28 may prevent the outer covering 36 from shifting or pulling back from the wire ends and may ensure that the insulation does not “pull back” 52 and expose the wire strands of the inner core at the surface of the assembly 10 as shown in FIG. 8. This may provide the benefit of a thinner assembly, that is L1 must only be slightly larger than L2 because the connector body 30 only needs to seal the outer covering 36, not provide mechanical support to the outer covering 36 to prevent “pull back” of the outer covering 36. This may also inhibit a leak path between the outer covering 36 and the wire strands, if the outer covering 36 does not bond well to the dielectric material of the connector body 30.

STEP 122, INSERT THE WIRE ARRANGEMENT INTO A MOLD, includes inserting the wire arrangement 38 into a mold within a molding machine 50.

Step 122 may optionally include STEP 124, ARRANGE A PLURALITY OF WIRE ARRANGEMENTS IN THE MOLD, which includes arranging a plurality of wire arrangements 38a-c in the mold so that the plurality of wire arrangements 38, a-c are electrically independent one-to-another. The plurality of wire arrangements 38a-c may be placed into a fixture 48 to hold plurality of wire arrangements 38a-c in place before being placed into the mold as shown in FIG. 6.

STEP 126, INJECT A DIELECTRIC MATERIAL IN A FLUID STATE INTO THE MOLD, includes injecting a dielectric material in a fluid state into the mold using a molding machine 50 to surround at least a portion of the wire arrangement 38 containing the wire splice element 32 to form the wire connector assembly 10.

Step 126 may optionally include STEP 128, INJECT A PORTION OF THE DIELECTRIC MATERIAL INTERMEDIATE TO THE END OF EACH WIRE CABLE, which includes injecting a portion of the dielectric material that forms the connector body 30 into the connecting portion 44 of the wire splice element 32 intermediate to the end of each wire cable 26, 28 to provide a barrier to a fluid infiltrating the inner core 34 of one of the plurality of wire cables 26, 28.

STEP 130, HARDEN THE DIELECTRIC MATERIAL TO A SOLID STATE, includes hardening the dielectric material to a solid state, thereby forming a connector body 30, wherein the connector body 30 encloses the wire splice element 32 and sealably engages the outer covering 36 of the plurality of wire cables 26, 28.

Accordingly, a wire feed-through connector assembly 10 that is configured to operate in fluid environments and a method 100 of constructing a wire feed-through connector assembly is provided. The assembly 10 provides electrical conductivity of the wire cables 26, 28 end-to-end through the connector body 30 of the assembly 10 in gaseous fluid environments 18, liquid fluid environments 24, or a combination of these environments. The assembly 10 inhibits fluid leakage through the wire strands of the inner core 34 of the wire cables 26, 28 because the ends of the wire cables 26, 28 are spaced apart and joined by a wire splice element 32, forming a physical barrier to fluid continuing a path through the assembly 10. Further, a portion of the connector body 30 is disposed between the ends of the wire cables 26, 28, providing an additional physical barrier to a fluid leak path through the assembly 10. The assembly 10 uses no solder in its construction, thus, there is no undesirable wicking of solder into portions of the wire cables 26, 28 outside the connector body 30. The insulation crimp wings 46 secure the ends of the outer covering, preventing pull back of the outer covering that may result in exposed wire stands near the first portion 20 or the second portion 22 of the connector body 30.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. A wire connector assembly comprising:
a connector body formed of a dielectric material;
a plurality of wire cables formed of an electrically conductive inner core surrounded by an electrically insulative outer covering, each wire cable having an outer covering end portion removed to expose an inner core end portion, wherein each inner core comprises a plurality of wire strands; and
a wire splice element electrically and mechanically joining at least two inner core end portions, wherein the at least two inner core end portions are axially spaced apart and wherein the connector body encloses said wire splice element and sealably engages each outer covering of the plurality of wire cables.

2. The wire connector assembly according to claim 1, wherein the plurality of wire cables, the wire splice element, and the connector body provide a fluid resistant electrically conductive path through the wire connector assembly.

3. The wire connector assembly according to claim 2, wherein a portion of the connector body is disposed intermediate to the at least two inner core end portions to provide a barrier to a fluid infiltrating the inner core of one of the plurality of wire cables.

4. The wire connector assembly according to claim 1, wherein the wire splice element defines a plurality of wire crimp wings.

5. The wire connector assembly according to claim 4, wherein said wire crimp wings are axially spaced apart.

6. The wire connector assembly according to claim 4, wherein the wire splice element further defines a plurality of insulation crimp wings configured to retain the outer covering.

7. The wire connector assembly according to claim 6, wherein the plurality of insulation crimp wings is distinct from the plurality of wire crimp wings.

8. A method to fabricate a wire connector assembly, comprising:
providing a plurality of wire cables and a wire splice element, wherein the plurality of wire cables are formed of an electrically conductive inner core surrounded by an electrically insulative outer covering;
removing the outer covering from an end of each wire cable to expose the inner cores of the plurality of wire cables;
inserting the end of each wire cable in the wire splice element;
electrically and mechanically attaching the end of each wire cable to the wire splice element to form a wire arrangement;
inserting the wire arrangement into a mold;
injecting a dielectric material in a fluid state into the mold to surround at least a portion of the wire arrangement containing the wire splice element to form the wire connector assembly; and
hardening the dielectric material to a solid state, thereby forming a connector body, wherein the connector body encloses said wire splice element and sealably engages the outer covering of the plurality of wire cables.

9. The method of claim 8, wherein the wire splice element defines a plurality of wire crimp wings and wherein the step of electrically and mechanically attaching the end of each wire cable to the wire splice element includes crimping the plurality of wire crimp wings to the end of each wire cable.

10. The method of claim 9, wherein said wire crimp wings are axially spaced apart.

11. The method of claim 10, wherein the step of injecting the dielectric material into the mold includes the step of injecting a portion of the dielectric material intermediate to the end of each wire cable to provide a barrier to a fluid infiltrating the inner core of one of the plurality of wire cables.

12. The method of claim 9, wherein the wire splice element further defines a plurality of insulation crimp wings configured to retain the outer covering and wherein the step of electrically and mechanically attaching the end of each wire cable to the wire splice element includes crimping the plurality of insulation crimp wings to the outer cover of each wire cable.

13. The method of claim 12, wherein the plurality of insulation crimp wings is distinct from the plurality of wire crimp wings.

14. The method of claim 8, wherein the step of inserting the wire arrangement into the mold further includes the step of arranging a plurality of wire arrangements in the mold so that the plurality of wire arrangements are electrically independent one-to-another.
